(19) United States
(12) Patent Application Publication
(10) Pub. No.: US 2022/0363232 A1
(43) Pub. Date: Nov. 17, 2022

(54) ELECTROMECHANICAL BRAKE PRESSURE GENERATOR FOR A HYDRAULIC BRAKE SYSTEM OF A VEHICLE, AND VEHICLE HAVING AN ELECTROMECHANICAL BRAKE PRESSURE GENERATOR

(71) Applicant: Robert Bosch GmbH, Stuttgart (DE)

(72) Inventors: Sebastian Martin REICHERT, Affaltrach (DE); Florian Kemmer, Boxberg-Schwabhausen (DE)

(21) Appl. No.: 17/620,094

(22) PCT Filed: Feb. 10, 2020
(86) PCT No.: PCT/EP2020/053256

§ 371 Date: Jan. 20, 2022

(30) Foreign Application Priority Data
Apr. 25, 2019 (DE) 10 2019 205 979.1

(51) Int. Cl. B60T 13/74; B60T 13/14; B60T 13/66

(52) U.S. Cl. CPC B60T 13/745; B60T 13/143; B60T 13/746; B60T 13/662

(57) ABSTRACT

An electromechanical brake pressure generator for a hydraulic brake system of a vehicle. The electromechanical brake pressure generator includes a screw drive system for converting a drive-side rotary movement into a translation movement to generate brake pressure. The screw drive system includes a spindle which is rotatable via an electric motor, a spindle nut, which interacts with a thread of the spindle so that the spindle nut is axially displaceable by a rotation of the spindle, and a drive wheel, which is situated coaxially on the spindle in a torsionally fixed manner and via which the spindle is connected to the electric motor. The drive wheel is developed from at least two different materials. A first material forms at least a wheel hub of the drive wheel. A second material forms at least a drive ring enclosing the wheel hub. The first material has greater strength than the second material.

The present invention relates to an electromechanical brake pressure generator for a hydraulic brake system of a vehicle and to a vehicle that includes an electromechanical brake pressure generator.

The electromechanical brake pressure generator may also be used as a brake booster in which an input braking force is amplified. More particularly, the electromechanical brake pressure generator or booster includes a screw drive system for converting a drive-side rotary movement into a translation movement for a brake pressure generation or for brake boosting. For the sake of simplicity, only a brake pressure generator is mentioned in the following text.

### BACKGROUND INFORMATION

The force of the driver's foot is usually insufficient to decelerate passenger cars so that the cars are usually equipped with a brake booster. Brake boosters often operate using vacuum pressure which is generated by the internal combustion engine. In addition to the force applied by the driver's foot, the pressure differential between the engine pressure and the ambient pressure is utilized to apply an amplifying force to the piston rod of the piston-cylinder unit.

Future drive concepts of passenger cars will require alternative brake pressure generator devices because vacuum pressure is no longer available for operating a conventional vacuum brake booster. The electromechanical brake pressure generators described herein were developed for such a purpose.

The actuation force at the piston-cylinder unit is generated with the aid of an electric motor. Such electromechanical brake pressure generators may be used not only for supplying an auxiliary force but, in brake-by-wire systems, also for the exclusive supply of the actuating force. For this reason, electromechanical brake pressure generators are advantageous especially in the context of autonomous driving.

PCT Patent Application No. WO 2017/045804 A1 describes a conventional electromechanical brake booster, which is shown in FIG. 1. In contrast, the present invention is also directed to an electromechanical brake pressure generator which is able to apply a braking force independently of an operation of the brake pedal. The conventional booster 1 includes a spindle nut 2 and a (not sketched) electric motor by whose operation spindle nut 2 can be induced to rotate via a spur gear 3. Spindle nut 2 is in operative engagement with a spindle 4, which is why spindle 4 is able to be set into a translation movement along its spindle axis 5 with the aid of spindle nut 2 set into rotation. To ensure that spindle 4 no longer rotates because of the rotation of spindle nut 2, brake booster 1 has a bearing system 6 to which spindle 4 is firmly connected.

Bearing system 6 includes a clip 6a at whose edges two sliding bearings 6b are situated. Sliding bearings 6b run on tie rods 7 which essentially extend parallel to spindle axis 5. Via this bearing system 6, spindle 4 is movable in an axial direction and secured against twisting.

PCT Patent Application No. WO 2017/089008 A1 describes a hydraulic vehicle brake system having an electromechanical brake pressure generator which, as a power brake force generator, generates a braking force while the brake cylinder operable using muscle power merely serves as a setpoint actuator for the electromechanical brake pressure generator. The electromechanical brake pressure generator may thus also be actuated independently of the brake cylinder able to be operated by muscle power, which means that a braking operation is also possible in an autonomous driving state.

It is an object of the present invention to provide an electromechanical brake pressure generator having a screw drive system which can be produced more economically and by which sufficient torque is transmittable.

### SUMMARY

The object may be achieved by an electromechanical brake pressure generator in accordance with an example embodiment of the present invention. Further refinements and embodiments of the present invention are disclosed herein.

The present invention provides an electromechanical brake pressure generator for a hydraulic brake system of a vehicle. In accordance with an example embodiment of the present invention, the electromechanical brake pressure generator includes at least a screw drive system for converting a drive-side rotary movement into a translation movement in order to generate brake pressure. The screw drive system includes a spindle, which is rotatable via an electric motor as a drive, and a spindle nut which interacts with a thread of the spindle so that the spindle nut is axially displaceable by a rotation of the spindle.

A screw drive system is to be understood both as a pure spindle drive in which the spindle nut is in direct contact with the spindle, and as a ball-screw drive. A ball-screw drive is a helical gear having balls that are inserted between the spindle and the spindle nut. Both parts have a groove in the shape of a screw, which jointly form a screw-shaped tube filled with balls. The form-locked connection in the thread transversely to the screw line is not realized between the thread groove and the thread wall like in a pure spindle drive, but via the balls.

In addition, the screw drive system includes a drive wheel, which is situated coaxially on the spindle in a torsionally fixed manner and via which the spindle is connected to the electric motor, and the drive wheel is developed from at least two different materials, a first material forming at least a wheel hub of the drive wheel and a second material forming at least a drive ring enclosing the wheel hub, the first material having greater strength than the second material.

‘Coaxially in a torsionally fixed manner’ denotes that an axis of rotation of the drive wheel coincides with an axis of rotation of the spindle and that mutual twisting of the drive wheel and the spindle is usually not possible. A drive wheel in the sense of the present invention is understood to be any type of wheel that receives a drive torque via a motor. The drive wheel is preferably a spur gear which interacts with a gear unit. Alternatively, the drive wheel is a belt pulley which is connected to the drive via a pulley. In a further alternative, the drive wheel is a chain wheel which is connected to the drive via a chain.

The drive wheel may be in direct engagement with the electric motor. In the same way, the electric motor may be directly connected to an upstream gear unit that is in direct engagement with the drive wheel. A torsionally fixed connection between the drive wheel and the spindle is able to be established in a variety of ways. For example, the drive wheel may be connected to the spindle by form locking, e.g., in the form of a tooth system. In the same way, the drive wheel may be connected to the spindle in an integral fashion such as by welding. A force-locking connection in the form of a fit is possible as an alternative.

The drive wheel is therefore made up of a component that forms at least the hub of the drive wheel and a component that forms a drive ring to which a drive torque is applied to drive the spindle. Apart from the wheel hub, the material forming the wheel hub may thus also form further elements. The wheel hub and the drive ring are connected to one another in a form-locked, integral or force-locked manner so that drive torque is transmittable from the drive ring to the hub.

The material that is used to form the hub has greater strength than the material used to form the drive ring. This offers the advantage that the hub on which high torque is acting on account of the smaller diameter has greater strength. In contrast, a material that has lower strength may be used for the drive ring. Such materials are usually less expensive than materials offering great strength, which means that such a drive wheel is able to be produced more economically. Thus, the drive wheel is optimized with regard to the existing loads of the individual regions of the drive wheel. Despite the lower strength of the drive ring, there is no need to reduce the torque to be transmitted.

In one preferred embodiment of the present invention, the second material is a plastic material. For the drive train, POM (polyoxymethylene) or PA (polyamide) are preferably used as plastic. Plastic materials have the advantage of being cost effective and easy to process. For instance, the drive ring is able to be injection-molded onto the material of the hub. In addition, plastic usually provides a weight advantage. Given a suitable selection of the plastic material, one that additionally has lubricating properties may be selected. Such plastic materials having lubricating properties are advantageous in the case of spur gears, in particular. Overall, the drive wheel can therefore be produced in a cost-effective manner.

In a further preferred embodiment of the present invention, the first material is a metal. The first material forming the wheel hub is preferably sheet metal. Metal has greater strength than plastic. In contrast to a milled part, for instance, a sheet metal part is easier to machine.

The wheel hub made from metal is preferably produced from sheet metal in the form of a punched and bent part by stamping. In contrast to milling, for instance, these working steps may easily and advantageously be used in a series production. Such a wheel hub is then able to be produced in an uncomplicated and economical manner and has great strength.

In one advantageous further refinement of the present invention, the first material of the wheel hub is a plastic material. PA (polyamide) or PEEK (polyetheretherketone) is preferably used as plastic for the wheel hub. These plastics have sufficient strength to compensate for the loads that arise during the operation. In a further embodiment of the present invention, it is also possible to use alternative plastic materials or bioplastic materials. These alternative plastic materials are biologically degradable. In general, plastic is cost-effective and easy to process by way of injection molding. The use of plastic furthermore makes it possible to reduce the weight of such a wheel hub.

The first material of the wheel hub advantageously extends in a radial direction in a region of the second material of the drive ring. The material of the drive ring and the material of the wheel hub thus have an overlap region. In this overlap region, the material of the drive ring is reinforced by the stronger material of the wheel hub. This achieves greater strength of the entire drive wheel. The material of the wheel hub in this transition region is preferably situated within the material of the drive ring. This means that the material of the wheel hub in this overlap region is encased by the material of the drive ring. For example, when using plastic for the material of the drive ring, this is possible by injection-molding the material of the wheel hub in this overlap region. This simplifies a connection between the two materials.

The material of the wheel hub in the region of the axial extension may preferably have reinforcement elements, e.g., in the form of reinforcement ribs or crimping. In the same way, in a further preferred embodiment, an edge piece extending in the axial direction is situated on the part of the wheel hub extending in the radial direction. More particularly, this edge piece is developed at an outermost radial position. Via the reinforcement elements and the edge piece, greater strength of the entire drive wheel is achieved.

In a further advantageous embodiment of the present invention, the wheel hub has a plurality of axial and/or radial passages, which are penetrated by the plastic of the second material of the drive ring so that a form-locking connection is established between the two materials. These passages are gaps in the material which are preferably produced by drilling or punching. In the same way, these passages are able to be created by a correspondingly adapted injection die mold. The axial passages are preferably in a region of the wheel hub extending in the radial direction while the radial passages are preferably in a region extending in the axial direction, e.g., the edge piece. These passages create a form-locked connection between the two materials of the drive wheel. This improves the strength and durability of such a drive wheel.

According to one advantageous further refinement of the present invention, the drive wheel is fixed in place on the spindle in the axial direction. In other words, the drive wheel on the drive axle is not displaceable in the axial direction. Such a fixation, for instance, may be developed by welding the wheel hub to the spindle or via heat staking of the wheel hub or the spindle. The drive wheel and the spindle are therefore connected to each other both in a torsionally fixed and a non-displaceable manner in the axial direction.

The first material of the wheel hub and/or the second material of the wheel hub is/are preferably made of plastic and injection-molded onto the spindle. The drive wheel is thereby formed directly on the spindle. This makes it possible to provide a region on the spindle where the drive wheel is connected to the spindle in a form-locked manner. This saves an installation step of the drive wheel on the spindle. As a result, the drive wheel does not have to be slipped onto the spindle. The region on the spindle may already be axially separated in this way, which means that no axial fixation would be required. Because of this injection-molding step, the drive wheel is able to be developed on the spindle in a simpler and more economical manner.

In addition, the present invention provides a vehicle having an electromechanical brake pressure generator for a hydraulic brake system. Such a vehicle makes it possible to achieve the advantages mentioned in connection with the electromechanical brake pressure generator. In one preferred embodiment, this vehicle may be an automated or fully autonomous vehicle.

Exemplary embodiments of the present invention are shown in the figures and described in greater detail in the following description.

### BRIEF DESCRIPTION OF THE DRAWINGS

FIG. 1 shows an illustration of an electromechanical brake booster from the related art;

FIG. 2 shows a simplified schematic illustration of a hydraulic brake system from the related art for a vehicle having an electromechanical brake pressure generator.

FIG. 3 shows a longitudinal sectional view of a first exemplary embodiment of a screw drive system for an electromechanical brake pressure generator according to an example embodiment of the present invention.

FIG. 4 shows a perspective view of the first material forming the wheel hub shown in FIG. 3.

FIG. 5 shows a perspective longitudinal sectional view of a second exemplary embodiment of a screw drive system for an electromechanical brake pressure generator.

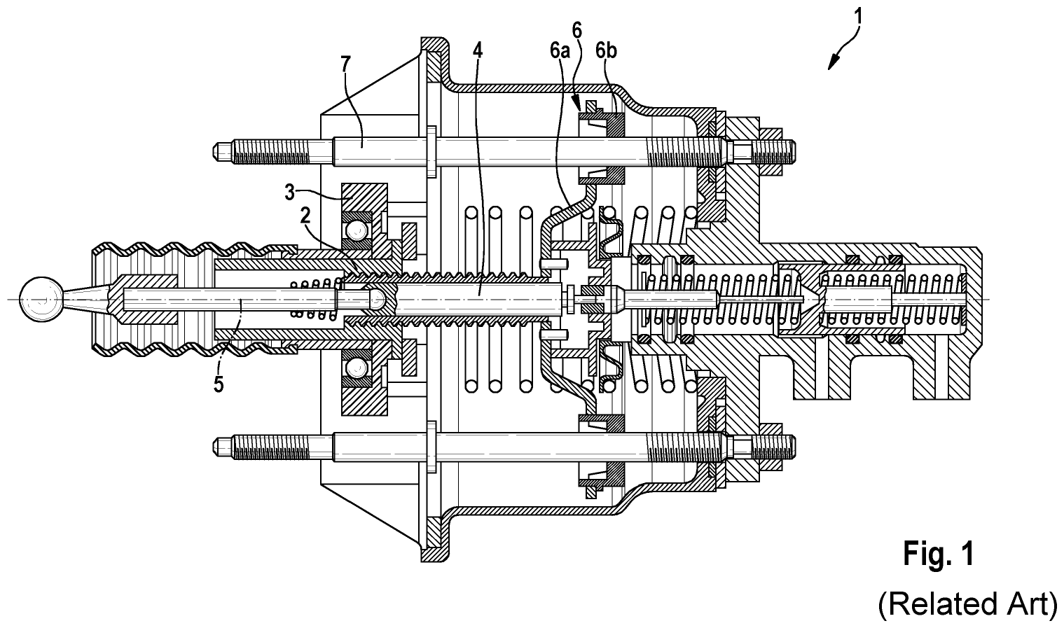

### DETAILED DESCRIPTION OF EXAMPLE EMBODIMENTS

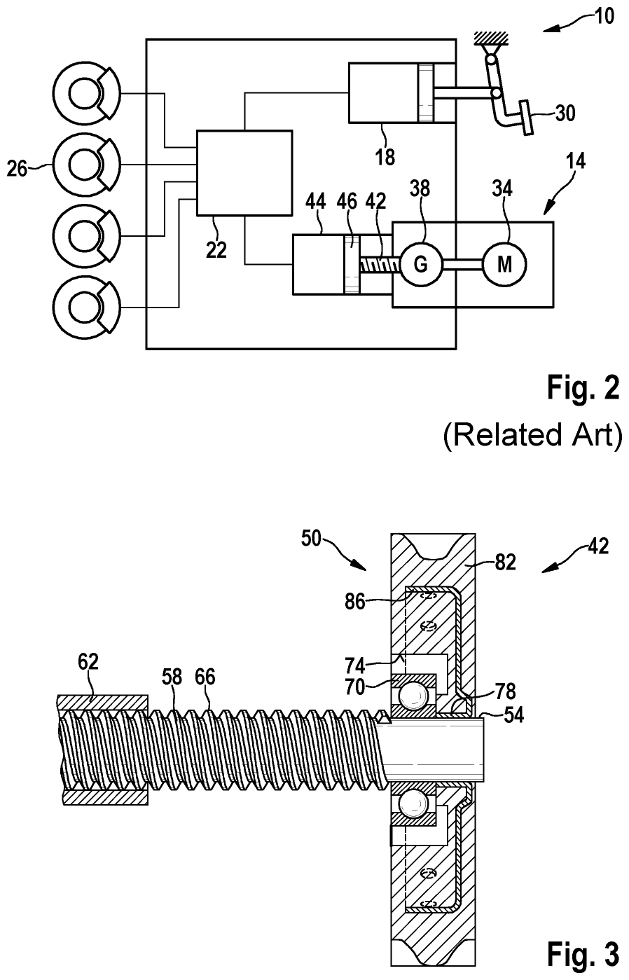

FIG. 2 shows a simplified schematic representation of a hydraulic brake system 10 from the related art for a vehicle having an electromechanical brake pressure generator 14. Hydraulic brake system 10 includes electromechanical brake pressure generator 14 and a piston/cylinder unit 18.

Piston/cylinder unit 18 and electromechanical brake pressure generator 14 are both hydraulically connected to a brake hydraulics system 22, which is depicted here only as a box.

Brake hydraulics system 22 is formed by various valves and further components in order to form an electronic stability program (ESP), for example. To be able to decelerate the vehicle, brake hydraulics system 22 is additionally connected to at least one wheel brake device 26 so that a brake force can be applied at wheel brake device 26 by switching the valves appropriately.

Piston/cylinder unit 18 is operated by muscle power via a brake pedal 30. The braking force of electromechanical brake pressure generator 14, on the other hand, is generated via an electric motor 34. To this end, electric motor 34 is connected to a gear unit 38 via which a screw drive system 42 is driven. Screw drive system 42 is connected to a hydraulic piston 46 situated in a hydraulic cylinder 44 so that a brake pressure is able to be generated.

FIG. 3 shows a longitudinal sectional view of a first exemplary embodiment of a screw drive system 42 for an electromechanical brake pressure generator 14 according to the present invention. Electromechanical brake pressure generator 14 according to the present invention is able to be used in hydraulic brake system 10 shown in FIG. 2. Screw drive system 42 includes a drive wheel 50, which is situated coaxially in a torsionally fixed manner on an axial end region 54 of a spindle 58. In this exemplary embodiment, spindle 58 is made of metal. Drive wheel 50 is connected to electric motor 34 as a drive so that spindle 58 together with drive wheel 50 is rotatable via electric motor 34. Screw drive system 42 additionally includes a spindle nut 62, which surrounds a section of spindle 58 and meshes with a thread 66 of spindle 58. Spindle nut 62 is protected against twisting so that it is axially displaceable by rotating spindle 58.

Moreover, screw drive system 42 includes a bearing 70 via which spindle 58 is rotatably mounted. This bearing 70 in this particular exemplary embodiment is disposed in a recess 74 in the region of drive wheel 50 so that axial space for bearing 70 is able to be reduced.

Drive wheel 50, which is embodied as a spur gear having an external tooth system in this exemplary embodiment, includes a first material which forms wheel hub 78 in this exemplary embodiment, and a second material, which forms a drive ring 82 having an external tooth system. The material forming wheel hub 78 is made from sheet metal in this exemplary embodiment, extends in a radial direction and forms an edge piece 86 that extends in the axial direction. Edge piece 86 is situated at an outer radial end of the region extending in the radial direction.

In this exemplary embodiment, plastic is used as the material for drive ring 82. This plastic material encloses the part of the material of wheel hub 78 that extends in the radial and axial directions. The plastic material is thereby reinforced by the stronger material of wheel hub 78.

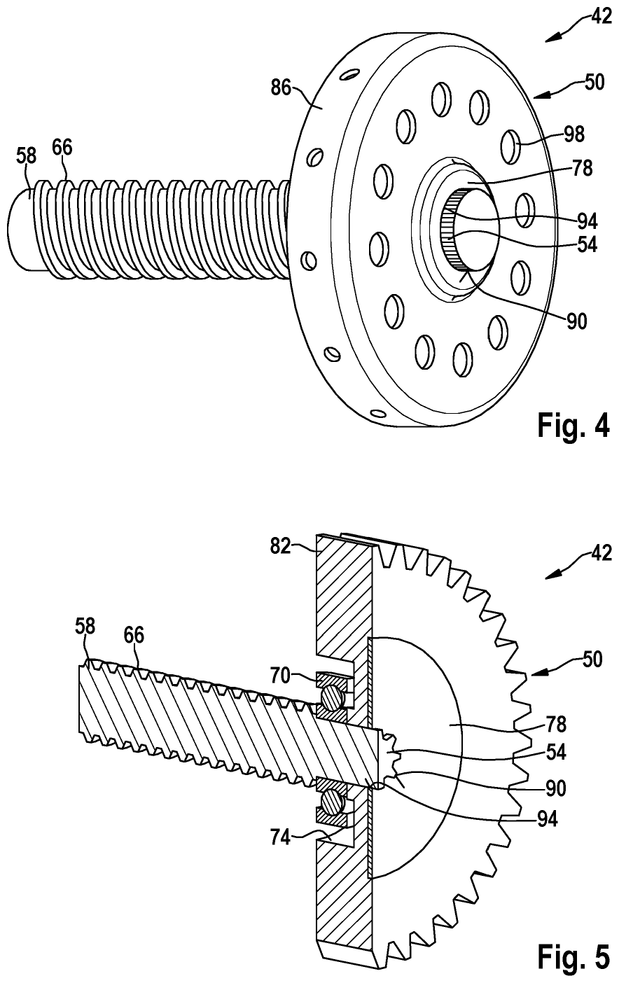

FIG. 4 shows a perspective view of the first material depicted in FIG. 3 that forms wheel hub 78. The second material, which forms drive ring 82, thus has been emitted in this figure. In addition, spindle nut 62 from FIG. 3 is not shown in this figure for the sake of clarity. It may be gathered from FIG. 4 that spindle 58 has an external spindle tooth system 90 in the region to which drive wheel 50 is fastened in order to establish a form-locked connection between drive wheel 50 and spindle 58.

Wheel hub 78 forms a corresponding internal wheel hub tooth system 94, which interacts with external spindle tooth system 90 in a form-locked manner so that drive wheel 50 is connected to spindle 58 in a torsionally fixed manner. In this exemplary embodiment, external spindle tooth system 90 is developed up to an axial end of spindle 58. This makes it possible to slip drive wheel 50 from this end onto spindle 58.

FIG. 4 additionally shows that the part of wheel hub 78 extending in the radial direction and edge piece 86 have a plurality of axial and/or radial passages 98, which are developed in the form of bores. The plastic material enclosing wheel hub 78 penetrates these passages and is thereby connected to wheel hub 78 in a form-locked manner.

FIG. 5 shows a perspective longitudinal sectional view of a second exemplary embodiment of a screw drive system 42 for an electromechanical brake pressure generator 14. For the sake of simplicity, spindle nut 62 has been omitted in this figure. This second exemplary embodiment differs from the first exemplary embodiment in that in addition to drive ring 82, plastic material is also used for the first material that forms wheel hub 78. The plastic forming wheel hub 78 has greater strength than the plastic of drive ring 82.

Similar to the first exemplary embodiment, the material of wheel hub 78 extends in the radial direction in order to reinforce the material of drive ring 82. This drive wheel 50 is produced as a two-component injection cast. For instance, this means that wheel hub 78 is developed first and drive ring 82 is injection-molded subsequently.

1-10. (canceled)

11. An electromechanical brake pressure generator for a hydraulic brake system of a vehicle, comprising:
a screw drive system configured to convert a drive-side rotary movement into an output-side translation movement; and
a piston/cylinder unit which is actuable by the screw drive system to generate brake pressure;
wherein the screw drive system includes:
a spindle which is rotatable via an electric motor as a drive,
a spindle nut which interacts with a thread of the spindle so that the spindle nut is axially displaced by a rotation of the spindle, and
a drive wheel which is situated coaxially on the spindle in a torsionally fixed manner and via which the spindle is connected to the electric motor, wherein the drive wheel is formed from at least two different materials, a first material forming at least a wheel hub of the drive wheel, and a second material forming at least a drive ring enclosing the wheel hub, and the first material has greater strength than the second material.

12. The electromechanical brake pressure generator as recited in claim 11, wherein the second material is a plastic material.

13. The electromechanical brake pressure generator as recited in claim 11, wherein the first material is a metal.

14. The electromechanical brake pressure generator as recited in claim 13, wherein the wheel hub made from metal is produced from sheet metal as a punched and bent part by stamping.

15. The electromechanical brake pressure generator as recited in claim 11, wherein the first material of the wheel hub is a plastic material.

16. The electromechanical brake pressure generator as recited in claim 11, wherein the first material of the wheel hub extends in a radial direction in a region of the second material of the drive ring.

17. The electromechanical brake pressure generator as recited in claim 12, wherein the wheel hub has a plurality of axial and/or radial passages, which are penetrated by the plastic of the second material of the drive ring so that a form-locked connection is established between the two materials.

18. The electromechanical brake pressure generator as recited in claim 11, wherein the drive wheel is fixed in place on the spindle in an axial direction.

19. The electromechanical brake pressure generator as recited in claim 11, wherein the first material of the wheel hub and/or the second material of the drive ring is made of plastic and injection-molded onto the spindle.

20. A vehicle comprising an electromechanical brake pressure generator for a hydraulic brake system of the vehicle, the electromechanical brake pressure generator including:
a screw drive system configured to convert a drive-side rotary movement into an output-side translation movement; and
a piston/cylinder unit which is actuable by the screw drive system to generate brake pressure;
wherein the screw drive system includes:
a spindle which is rotatable via an electric motor as a drive,
a spindle nut which interacts with a thread of the spindle so that the spindle nut is axially displaced by a rotation of the spindle, and
a drive wheel which is situated coaxially on the spindle in a torsionally fixed manner and via which the spindle is connected to the electric motor,
wherein the drive wheel is formed from at least two different materials, a first material forming at least a wheel hub of the drive wheel, and a second material forming at least a drive ring enclosing the wheel hub, and the first material has greater strength than the second material.
